(19) United States
(12) Patent Application Publication
(10) Pub. No.: US 2010/0022697 A1
(43) Pub. Date: Jan. 28, 2010

(54) PROCESS FOR MICROENCAPSULATION OF PHASE CHANGE MATERIALS, MICROCAPSULES OBTAINED AND USES THEREOF

(75) Inventors: Juan Francisco Rodriguez Romero, Ciudad Real (ES); Maria Luz Sanchez Silva, Ciudad Real (ES); Paula Sanchez Paredes, Ciudad Real (ES); Antonio De Lucas Martinez, Ciudad Real (ES); Martha Liliana Torres Barreto, Talavera De La Reina (ES)

Correspondence Address: CANTOR COLBURN, LLP, 20 Church Street, 22nd Floor, Hartford, CT, 06103, US

(73) Assignee: UNVERSIDAD DE CASTILLA-LA MANCHA, Albacete (ES)

(21) Appl. No.: 12/293,931

(22) PCT Filed: Mar. 23, 2006
(86) PCT No.: PCT/EP06/02654

§ 371 Date: Jan. 27, 2009

(51) Int. Cl. C08F 2/24

(52) U.S. Cl. 524/461; 524/725; 524/755; 524/765; 524/770; 524/773; 524/792; 524/834; 524/836; 524/849; 524/855

(57) ABSTRACT

The invention relates to a process for microencapsulation of phase change materials based on free radicals polymerization comprising: a) the preparation of i) a solution with, at least, a hydrophilic liquid and a stabilizer (continuous phase) and ii) a solution with, at least, a phase change material, a free radical initiator and a polymerizable material (discontinuous phase); b) the preparation of an emulsion by dispersing the discontinuous phase in the continuous phase under vigorous stirring; and c) the polymerization of monomers until the phase change material becomes microencapsulated. This process is simple and effective and avoids the use of hazardous compounds. The invention also relates to microcapsules obtainable by said process and to the use thereof in the thermal protection and storage of heat.

### FIELD OF THE INVENTION

This invention relates to microencapsulation of phase change materials. More particularly, it relates to a process for microencapsulation of phase change materials based on free radical polymerization and to the resulting microcapsules.

### BACKGROUND OF THE INVENTION

The active agent that lodges inside the microcapsules is a phase change material also called PCM and it is the main protagonist in the storage of thermal energy. The PCMs are materials with high heats of fusion. They can absorb or release the latent heat when the temperature of the material undergo or overpass the temperature of change of phase. A variety of phase change materials available are well known for their thermal characteristics, these materials exist in the market (hydrated salts, paraffins or waxes, organic, inorganic and fatty acids) and they can be encapsulated by a polymer cover.

The storage media employed hitherto in latent heat-storage systems are usually substances which have a solid-liquid phase transition in the temperature range which is essential for the use, i.e. substances which melt during use.

The election of the appropriate material depends on the final application, the materials that melted below 15° C. are used to keep the cold in the air conditioning, while the materials that melted around 90° C. for the absorption in the cooling.

The fact of possessing a great capacity of thermal storage makes that the PCMs are very applied in the industry. The industrial applications of the PCMs can be divided in two big groups:
Thermal protection.
Storage of heat.

When we refer to thermal protection, we are considering those materials that present lower values of thermal conductivity. On the contrary, in the storage systems, the fact of having materials with lower thermal conductivity is a problem because these systems can kept the energy but they are unable to release that energy in a quick way.

The use of the PCMs for the thermal storage in the buildings was one of the first studied applications. The first work published on this phenomenon appears in the 1970s. It comments as the buildings are recovered with a thin layer of sensitive materials whose function is to protect the external part of the building. The PCMs are used in walls, floors or block ending up possessing fireproof characteristics.

For the absorption, accumulation and emission of thermal energy can be used the mainly paraffin, because it takes advantage of the liberated energy or consumed in the different phase changes as a response to thermal stimuli; it is gotten an accumulation or energy detachment when passing from solid state to liquid state, and vice versa, this is described in the U.S. Pat. No. 2003/0222378 A1.

Textiles and other products incorporated with the phase change materials, especially in the microencapsulated forms, may establish a microclimate surrounding the modified goods in the temperature ranges of the melting points of the employed PCMs and so may meet the requirement for comfort. The use of microencapsulated PCMs in textiles may be found in U.S. Pat. Nos. 4,756,958 and 5,290,904.

Thus, the literature discloses the use of paraffins as storage medium in latent heat-storage systems. U.S. Pat. No. 5,709,945 describes a process for preparing a heat storage capsule, which has at least one layer of a hydrophobic wax and one to three layers of polymeric materials where the polymer solution that form the shell is sprayed on the surface of the spheres made from the phase change composition on a fluidized bed. On other hand, other phase change materials are described in U.S. Pat. No. 4,797,160, where employed compositions containing crystalline, straight chain, alkyl hydrocarbons as phase change materials including cementitious compositions containing the alkyl hydrocarbons neat or in pellets or granules formed by incorporating the alkyl hydrocarbons in polymers or rubbers; and polymeric or elastomeric compositions containing alkyl hydrocarbons.

Recently, methods for microencapsulation are developed wherein macrocapsules contain microencapsulated phases change materials. The procedure described herein can also be used to encapsulate a variety of materials, such as fragrances, pharmaceuticals, pesticides, oils, lubricants, and the like, as described in U.S. Pat. No. 2004/0169299 A1. The PCMs here employed are preferably paraffinic hydrocarbons having from 13 to 28 carbon atoms.

U.S. Pat. No. 2003/0222378 A1, cited before, describes a method for the encapsulation of phase change materials (PCMs) involving interfacial polymerization to form the double-shell microcapsules with relatively low shell permeability. Polyisocyanates having two isocyanate groups and three to eight carbon atoms, including the two carbon atoms in the two isocyanate groups where employed to form the first layer. Polyamines with three or more functional groups such as diethylenetriamine and tetraethylenepentamine where claimed as suitable to form the second layer. U.S. Pat. Nos. 5,456,852 and 5,916,478 both describes processes of microcapsule manufacturing employing in situ polymerization of aminoplast resins, where the cover is formed by melamine-formaldehyde polymer.

Other processes are described in order to improve the final properties of microencapsulation method such as U.S. Pat. No. 2005/0121814 where the microencapsulation is carried out using a microencapsulation apparatus, which comprising a first microsphere dispenser and a second microsphere dispenser arranged in alignment with the first microsphere dispenser, wherein the apparatus is configured to form co-axial multi-lamellar microcapsules from materials discharged form the first and second microsphere dispensers.

Hence there is still a need in the art for an alternative microencapsulation method which allows the microencapsulation of phase change materials (PCMs) in a simple and efficient way and avoiding the use of hazardous compounds such as isocyanate derivatives or formaldehyde. This method is less complicated and cheaper than other involving in situ or interphase polymerization.

The present inventors have found that the microencapsulation of phase change materials can be carried out by a free radical polymerization process, specifically by a free radical pearl polymerization process, to form the shell, in a simpler and more effective way while avoiding the use of hazardous compounds, as explained before. The shell is constituted by a polymeric material, whose monomers are added initially in a discontinuous phase, and the core is constituted by the phase change material which is also added initially in the discontinuous phase. So that this PCM encapsulation method has not been previously described in literature, nor patented.

### OBJECT OF THE INVENTION

Therefore it is an object of the present invention to provide a process for microencapsulation of phase change materials based on free radicals polymerization that comprises: a) the preparation of a continuous phase including at least a hydrophilic liquid and a stabilizer, and a discontinuous phase including at least a phase change material, a free radical initiator and a polymerizable material; b) the preparation of an emulsion by dispersing said discontinuous phase in said continuous phase under vigorous stirring; and c) the polymerization of monomers until the phase change material becomes microencapsulated.

Another object of the invention is to provide the microcapsules obtainable by said process.

Finally, another object of the invention is to provide the use of said microcapsules in the thermal protection and storage of heat.

### BRIEF DESCRIPTION OF FIGURES

FIG. 1 shows the Differential Scanning Calorimetry (DSC) thermogram of a microcapsule of polystyrene containing paraffin as phase change material, that has been obtained by the process of the invention.

### DETAILED DESCRIPTION OF THE INVENTION

The present invention provides a process for microencapsulation of phase change materials based on free radicals polymerization (hereinafter called “the process of the invention”) comprising:

a) the preparation of i) a solution with, at least, a hydrophilic liquid and a stabilizer (continuous phase) and ii) a solution with, at least, a phase change material, a free radical initiator and a polymerizable material (discontinuous phase);

b) the preparation of an emulsion by dispersing the discontinuous phase in the continuous phase under vigorous stirring; and

c) the polymerization of monomers until the phase change material becomes microencapsulated.

This method for microencapsulating a phase change material (hereinafter called PCMs) consists in dispersing droplets of the molten PCM in a hydrophilic liquid (an aqueous solution, for example) and forming walls around the droplets by free radical polymerization.

The present invention thus is directed to produce microcapsules that contain therein a PCM for energy storage, for example.

This process for the encapsulation of PCMs is characterized in that a w/o emulsion (i.e. hydrophilic in hydrophobic, for example water in oil) or o/w emulsion (i.e. hydrophobic in hydrophilic, for example oil in water) is prepared from a first solution (discontinuous phase) and a second solution (continuous phase) by dispersing the first one into the later one under vigorous stirring. The stabilizer content and the stirring speed play an important role in drop size distribution. In the droplets of this emulsion the polymerization proceeds by a free radical mechanism to form a polymeric matrix or shell which will encapsulate the hydrophilic liquid and the PCM. The polymerization of the polymerizable material, vinyl monomers, for example, involves a series of stages. The polymerization process needs an initiator of the reaction which generates a free radical. This radical unites to the molecule of the vinyl monomer forming in this way another free radical that adds to another vinyl monomer molecule, and so forth. The polymer chain and the reaction ends with the union of two radicals that consume, but not generates radicals.

The first solution formed contains at least one hydrophilic liquid and one stabilizer, and can be called “the continuous phase”, and the second solution formed contains the PCM, the initiator and the polymerizable material, and can be called “the discontinuous phase”. This discontinuous phase is dispersed in the continuous phase (considered as an inert medium), and this step is usually performed under vigorous stirring. The stirring speed in the polymerization has influence on the particle size.

As the PCM is usually organic and hydrophobic in nature, water is usually chosen as hydrophilic liquid for the continuous phase. The temperature of the discontinuous phase should be kept at least 5° C. higher than the melting point of the PCM to ensure that the PCM is in a liquid state. This may be carried out by means of a suitable bath technique of the state of the art.

In an embodiment of the process of the invention, the polymerization temperature depends on the decomposition temperature of the free radical initiator used. It is in general of 50 to 150° C., preferably 55 to 120° C.

In another embodiment of the process of the invention, the polymerization takes from 1 to 8 hours.

It has proved useful to use a temperature programme in which the polymerization is started at low temperature, e.g. 55° C., and the reaction temperature is increased as the polymerization conversion progresses. In this way, for example, the requirement for the safe reaction and high polymerization conversion can be very readily met.

In one embodiment of the process of the invention, the hydrophilic liquid of the continuous phase is selected from water, dimethyl formamide, dimethyl acetamide, dimethyl sulfoxide, N-methyl pyrrolidone, triacetin or mixtures thereof. Water is preferably used as the hydrophilic liquid.

The hydrophilic liquid is used in quantities of 1 to 99, preferably 6 to 95 and more particularly 10 to 90% by weight, based on the final composition of the emulsion, in the process according to the invention.

Then, in a preferred embodiment of the process of the invention, the hydrophilic liquid is present in 1-99% by weight, preferably 5-95% by weight, more preferably 10-90% by weight of the total emulsion.

As indicated, the hydrophilic liquid act as inert medium for the dispersion of the discontinuous phase containing the PCM and monomers forming drops.

In one embodiment of the process of the invention, the stabilizer is selected from polyvinyl alcohols, polyvinyl acetals, polyvinyl lactams or mixtures thereof. In one preferred embodiment, the stabilizer is selected from poly(vinylpyrrolidone), poly(N-vinylpiperidone), poly(N-vinylcaprolactam), poly(N-vinylcarbazole), poly(N-vinylimidazole) or mixtures thereof.

In one preferred embodiment, the stabilizer is present in 0.05-5% by weight, preferably 0.1-2% by weight, most preferably 0.25-1.5% by weight of the total emulsion.

Suitable stabilizers are polyvinyl compounds included for avoiding the coalescence and the aggregation of globules formed.

As the compound capable of undergoing phase transitions which is used in the present invention, any compound can be used so long as it has a melting point or a freezing point. Therefore, suitable PCMs to be encapsulated by the process of the invention can be any phase change material known to the expert of the art.

Specifically, there can be used inorganic compounds (sodium sulfate decahydrate, sodium thiosulfate pentahydrate, calcium chloride hexahydrate, magnesium nitrate hexahydrate) containing a large amount of water of crystallization and also organic compounds of diverse nature.

In one embodiment of the process of the invention, the PCM is selected from aliphatic hydrocarbons, cycloaliphatic hydrocarbons, aromatic hydrocarbons, halogenated aliphatic hydrocarbons, halogenated aromatic hydrocarbons, ketones, esters, ethers, glycol ethers, nitrile compounds, sulphur compounds, nitro compounds, oil components, polyols, fatty alcohols, fatty acids, alcohols, amides, amines or mixtures thereof.

In one preferred embodiment, the PCM is selected from tetradecane, pentadecane, hexadecane, eicosane, docosane, petroleum ether, spirit, paraffin, cyclohexane, methyl cyclohexane, decalin, benzene, toluene, xylene, ethylbenzene, cumene, dichloromethane chloroform, tetrachloromethane, trichloroethene, tetrachloroethene, ethylene chloride, chlorofluorocarbons, bromobenzene, acetone, butanone, cyclohexanone, methylcyclohexanone, alkyl myristate, alkyl palmitate, alkyl stearate, diethyl ether, dibutyl ether, anisole, dioxane, tetrahydrofurane, dimethyl acetal, monoethyleneglycol ethers, diethyleneglycol ethers, polyethyleneglycol ethers, acetonitrile, carbon disulfide, sulfolan, nitromethane, nitrobenzene, myristyl myristate, isopropyl myristate, cetyl oleate, stearyl palmitate, terpenes, terpenoids, propanediol, butanediol, pentanediol, hexanediol, glycols, polyethyleneglycols, 1,2,3-propanetriol, caproic alcohol, caprylic alcohol, lauryl alcohol, myristyl alcohol, stearyl alcohol, eicosanol, cetyl alcohol, myristic acid, palmitic acid, behenic acid, octanol, cyclohexanol, benzoyl alcohol, stearic acid amide, ethyleneisoleic acid amide, methylalolbehenic acid amide, N-phenyl-N′-stearylurea, pyridine, or mixtures thereof.

The preferred aliphatic hydrocarbons are straight-chain aliphatic hydrocarbons having 10 or more carbon atoms, such as tetradecane, pentadecane, hexadecane, eicosane or docosane. The preferable examples of esters as PCMs are alkyl esters such as alkyl myristate, alkyl palmitate or alkyl stearate, wherein alkyl is a lower alkyl group having 1 to 6 atoms of carbon, such as methyl, ethyl, propyl, etc. As oil components can be used terpenoids such as wood turpentine oil, balsam turpentine oil, pine oil, for example.

These PCMs may be used as a mixture of two or more thereof for producing a heat-storing material having a melting point fit for a purpose.

Also, another preferred chemical family used for PCMs are that of polyols such as glycols, polyethylene glycols, diols and triols, and mixtures thereof, usually with water, that have a phase change from liquid to solid within a desirable working range, for sample −30° C. to 70° C., although for many applications, a range of −10° C. to 50° C. is adequate. A mixture of polyols, with or without water, may be treated to avoid undercooling by addition of a nucleating agent. The basic chemical formula for glycols is (CH2)n(OH)2, triols have one more (OH) group. The combination of glycols with water results in a mixture with different melting point than the original glycol. The same can be done with any combination of glycols, triols, and water. Some exemplary useful polyols are listed below:
(a) Propanediol isomers. The 1,3-propanediol isomer has a melting point of approximately −27° C.
(b) Butanediol isomers. The 1,4-butanediol isomer has a melting point of approximately +20° C.
(c) Pentanediol isomers. The 1,5-pentanediol isomer has a melting point of approximately −16° C.
(d) Hexanediol isomers. The 1,6-hexanediol isomer has a melting point of approximately +41° C.
(e) Polyethylene glycols. These are categorized by molecular weight.
   PEG 300 freezing point −8 to −15° C.
   PEG 400 freezing point +4 to 8° C.
   PEG 600 freezing point +20 to 25° C.
   PEG 1500 freezing point +44 to 48° C.
   PEG 4000 freezing point +54 to 58° C.
   PEG 6000 freezing point +56 to 63° C.
(f) 1,2,3, Propanetriol (glycerin).

These compounds may be used singly or in combination of two or more thereof.

Generally, liquid materials with hydrophobic properties are more commonly employed as PCMs with additives such as surfactants and stabilizers being employed as dispersion agents.

In one preferred embodiment, the PCM is present in 0.5-50% by weight, preferably 1-25% by weight of the total emulsion.

In one embodiment of the process of the invention, the free radical initiator is selected from peroxy compounds, azo compounds, aliphatic peroxyesters or mixtures thereof. In one preferred embodiment, the free radical initiator is selected from dibenzoyl peroxide, dilauryl peroxide, bis(p-chlorobenzoyl peroxide), dicyclohexyl peroxydicarbonate, tert-butylperoctoate, 2,5-bis(2-ethylhexanoylperoxy)-2,5-dimethylhexane, tert-amylperoxy-2ethylhexane, 2,2′-azobisisobutyronitrile, 2,2′-azobis(2-methyliso-butyronitrile), tert-butyl peroxyisobutyrate, tert-butyl peroxypivalate, tert-butyl peroxy-2-ethylhexanoate, tert-butylperoxyneodecanoate, tert-amyl peroxy-2-ethylhexanoate, tert-amyl peroxyneodecanoate, 2,5-bis(2-ethylhexanoylperoxy)-2,5-dimethylhexane, 2,5-dipivaloyl-2,5-dimethylhexane or 2,5-bis(2-neodecanoylperoxy)-2,5-dimethylhexane or mixtures thereof. Mixtures of free radical initiators having different decomposition temperatures may be used, for example.

In one preferred embodiment, the free radical initiator is present in 0.01-5% by weight, preferably 0.1-2.5% by weight of the total emulsion.

Monomers to be used according to the invention are compounds having a polymerizable C double bond. Therefore, in one embodiment of the process of the invention, the polymerizable material is a monomer selected from styrene, vinyltoluene, divinylbenzene, ethylstyrene, alpha-methylstyrene, chlorostyrene, acrylic acid, methacrylic acid, acrylic esters, methacrylic esters, acrylonitrile, methacrylamide or mixtures thereof.

In one preferred embodiment, the polymerizable material is present in 5-50% by weight, preferably 10-35% by weight of the total emulsion.

The process of the invention can include the optional use of comonomers which are added to the discontinuous phase. Comonomers can be any monomer mono or multifunctional such as methymethacrilate, divinylbenzene, etc., and are included in order to modify the properties of the shell. Properties such as permeability, thermal conductivity, physical and chemical strength can be modified by using different kinds of comonomers.

The process according to the invention is based on the multifunctionality of the polymerizable components (the stabilizer and optionally the comonomer) and uses their self-organization at the boundary of the lipophilic/hydrophilic liquid in the emulsion. Accordingly, the process requires only a little wall.

In an embodiment of the process of the invention, the microcapsules obtained have a diameter of 10-250 μm.

In another aspect of the invention, microcapsules are provided which are obtainable by the process of the invention previously disclosed.

Although the thus obtained dispersion of the microcapsules encapsulating the PCM can achieve the object of the present invention as it is, there is, if necessary, obtained a desired PCM in the form of an aqueous liquid by adding ethylene glycol, propylene glycol, various inorganic salts, antiseptics, various stabilizers, thickeners, colorants, dispersion assistants, specific gravity adjustors, wetting agents, etc.

In another aspect of the invention, the use of said microcapsules is provided in the thermal protection and storage of heat.

As stated, the microcapsules of the present invention may be used in any application relating to the transfer and/or storage of heat.

In general, the use of these microcapsules in a specific field depends on the melting temperature of the PCM encapsulated. If the melting point of a PCM is near to the body temperature, for example, this PCM is useful for recovering clothes, for example. Other possible uses can be:
Passive storage and thermal protection in buildings.
Thermal storage of solar energy.
Thermal protection of food: transport, ice-creams, frozen foods, etc.
Medical applications: blood transport, operating tables, cold-hot therapies, etc.
Thermal protection of equipments (electrical and combustion equipments).
Thermal comfort in automotive vehicles.
Use in greenhouses.
Thermal protection in clothing (sky clothing, astronaut clothing, etc).

The microcapsules of the present invention may be used in an improved method of applying coating containing PCMs to fabrics without damage or degradation to PCMs and having the adapted qualities as coatings on fabrics by utilizing commercially available equipment.

Other specific examples include, but are not limited to, the use of these materials in HVAC systems and construction materials for residential and commercial buildings, home furnishings and automobile upholstery, heat sinks for computers, etc.

This invention is now illustrated by the following examples which shall not be interpreted as limiting.

### Examples

### Example 1

Microencapsulation of Paraffin with Polystyrene.

Polystyrene microcapsules containing paraffin had been prepared using the following reactants in the following proportions:

Recipe for continuous phase (Reaction vessel)

| | |
|---|---|
| Polyvinylpyrrolidone | 7.4 g |
| Water (Milli-Q) | 754 g |

Recipe for discontinuous phase (Bath II)

| | | |
|---|---|---|
| Paraffin | 54 | g |
| Dibenzoyl peroxide | 2.5 | g |
| Styrene | 156 | g |

### Procedures

1. The continuous phase is prepared by adding water and the stabilizer in the established proportions in the reaction vessel. It's mild stirring (200 rpm) for 10 minutes.

2. The discontinuous phase is prepared by adding the styrene, the paraffin and the initiator in the bath II.

3. Bath II is dispersed in the reaction vessel under vigorous stirring at 100° C.

4. The reaction vessel must be inertized during all reaction and the reaction was carried out for 6 hours.

Microscopic observation of the sample shows that the diameters of the microcapsules are ranging from 20 to 100 micrometer.

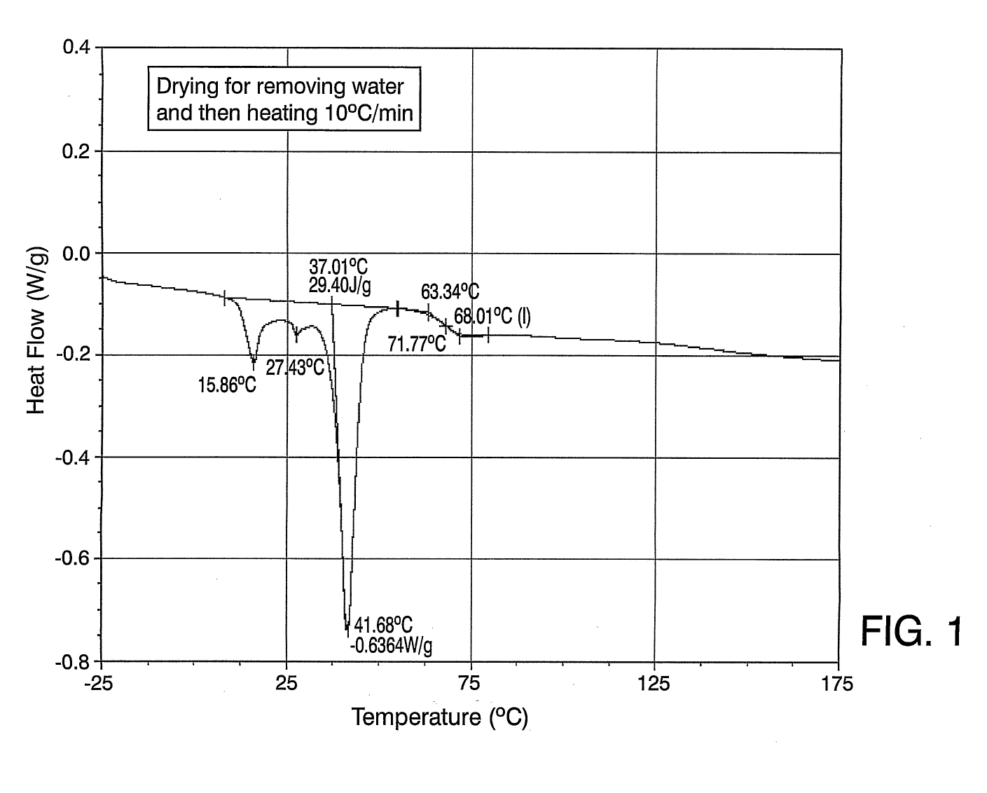

Thermal properties of the prepared paraffin/polystyrene microcapsules such as transition temperatures, melting temperatures and latent heat, were determined by a DCS (Differential Scanning Calorimetry) thermal analyser. The DSC thermal analyses were performed in the temperature range of −25-175° C. with a heating rate of 10° C./min and under a constant stream of nitrogen at atmospheric pressure. The latent heat was calculated as the total area under the peaks of solid-liquid transitions of the paraffin and it was determined as 48.92 J/g. FIG. 1 shows the DSC thermogram of the microcapsules of paraffin with polystyrene prepared.

### Example 2

Microencapsulation of Paraffin with Poly(styrene-co-methyl methacrylate).

Poly(styrene-co-methyl methacrylate) microcapsules containing paraffin had been prepared using the following reactants in the following proportions:

Recipe for continuous phase (Reaction vessel)

| | |
|---|---|
| Polyvinylpyrrolidone | 7.4 g |
| Water (Milli-Q) | 754 g |

Recipe for discontinuous phase (Bath II)

| | | |
|---|---|---|
| Paraffin | 78 | g |
| Dibenzoyl peroxide | 2.5 | g |
| Styrene | 45 | g |
| Methyl methacrylate | 189 | g |

### Procedures

1. The continuous phase is prepared by adding water and the stabilizer in the established proportions in the reaction vessel. It's mild stirring (200 rpm) for 10 minutes.

2. The discontinuous phase is prepared by adding the styrene, the methyl methacrylate, the paraffin and the initiator in the bath II.

3. Bath II is dispersed in the reaction vessel under vigorous stirring at 100° C.

4. The reaction vessel must be inertized during all reaction and the reaction was carried out for 6 hours.

Microscopic observation of the sample shows that the diameters of the microcapsules are ranging form 50 to 200 micrometer.

In this case the latent heat was 125.33 J/g. It was determined in the same way that in Example 1.

### Example 3

Microencapsulation of Polyethylene Glycols with Polystyrene

Polystyrene microcapsules containing polyethylene glycols (PEG 600 with freezing point of 20 to 25° C.) had been prepared using the following reactants in the following proportions:

Recipe for continuous phase (Reaction vessel)

| | |
|---|---|
| Polyvinylpyrrolidone | 7.4 g |
| Water (Milli-Q) | 754 g |

Recipe for discontinuous phase (Bath II)

| | | |
|---|---|---|
| PEG 600 | 54 | g |
| Dibenzoyl peroxide | 2.5 | g |
| Styrene | 156 | g |

### Procedures

1. The continuous phase is prepared by adding water and the stabilizer in the established proportions in the reaction vessel. It's mild stirring (200 rpm) for 10 minutes.

2. The discontinuous phase is prepared by adding the styrene, the polyethylene glycol and the initiator in the bath II.

3. Bath II is dispersed in the reaction vessel under vigorous stirring at 110° C.

4. The reaction vessel must be inertized during all reaction and the reaction was carried out for 6 hours.

Microscopic observation of the sample shows that the diameters of the microcapsules are ranging form 10 to 100 micrometer.

In this case the latent heat was 90.45 J/g. It was determined in the same way that in Example 1.

1. Process for microencapsulation of phase change materials based on free radicals polymerization comprising:
a) the preparation of i) a solution with, at least, a hydrophilic liquid and a stabilizer (continuous phase) and ii) a solution with, at least, a phase change material, a free radical initiator and a polymerizable material (discontinuous phase),
b) the preparation of an emulsion by dispersing the discontinuous phase in the continuous phase under vigorous stirring, and
c) the polymerization of monomers until the phase change material becomes microencapsulated;
characterised in that the polymerizable material is a monomer selected from styrene, vinyltoluene, divinylbenzene, ethylstyrene, alpha-methylstyrene and chlorostyrene or mixtures thereof.

2. Process according to claim 1 wherein the hydrophilic liquid is selected from water, dimethyl formamide, dimethyl acetamide, dimethyl sulfoxide, N-methyl pyrrolidone, triacetin or mixtures thereof.

3. Process according to claim 2 wherein the hydrophilic liquid is present in 1-99% by weight, preferably 5-95% by weight, more preferably 10-90% by weight of the total emulsion.

4. Process according to claim 1 wherein the stabilizer is selected from polyvinyl alcohols, polyvinyl acetals, polyvinyl lactams or mixtures thereof.

5. Process according to claim 4 wherein the stabilizer is selected from poly(vinylpyrrolidone), poly(N-vinylpiperidone), poly(N-vinylcaprolactam), poly(N-vinylcarbazole), poly(N-vinylimidazole) or mixtures thereof.

6. Process according to claim 4 wherein the stabilizer is present in 0.05-5% by weight, preferably 0.1-2% by weight, most preferably 0.25-1.5% by weight of the total emulsion.

7. Process according to claim 1 wherein the phase change material is selected from aliphatic hydrocarbons, cycloaliphatic hydrocarbons, aromatic hydrocarbons, halogenated aliphatic hydrocarbons, halogenated aromatic hydrocarbons, ketones, esters, ethers, glycol ethers, nitrile compounds, sulphur compounds, nitro compounds, oil components, polyols, fatty alcohols, fatty acids, alcohols, amides, amines or mixtures thereof.

8. Process according to claim 7 wherein the phase change material is selected from tetradecane, pentadecane, hexadecane, eicosane, docosane, petroleum ether, spirit, paraffin, cyclohexane, methyl cyclohexane, decalin, benzene, toluene, xylene, ethylbenzene, cumene, dichloromethane, chloroform, tetrachloromethane, trichloroethene, tetrachloroethene, ethylene chloride, chlorofluorocarbons, bromobenzene, acetone, butanone, cyclohexanone, methylcyclohexanone, alkyl myristate, alkyl palmitate, alkyl stearate, diethyl ether, dibutyl ether, anisole, dioxane, tetrahydrofurane, dimethyl acetal, monoethyleneglycol ethers, diethyleneglycol ethers, polyethyleneglycol ethers, acetonitrile, carbon disulfide, sulfolan, nitromethane, nitrobenzene, myristyl myristate, isopropyl myristate, cetyl oleate, stearyl palmitate, terpenes, terpenoids, propanediol, butanediol, pentanediol, hexanediol, glycols, polyethyleneglycols, 1,2,3-propanetriol, caproic alcohol, caprylic alcohol, lauryl alcohol, myristyl alcohol, stearyl alcohol, eicosanol, cetyl alcohol, myristic acid, palmitic acid, behenic acid, octanol, cyclohexanol, benzoyl alcohol, stearic acid amide, ethyleneisoleic acid amide, methylalolbehenic acid amide, N-phenyl-N′-stearylurea, pyridine, or mixtures thereof.

9. Process according to claims 7 wherein the phase change material is present in 0.5-50% by weight, preferably 1-25% by weight of the total emulsion.

10. Process according to any claim 1 wherein the free radical initiator is selected from peroxy compounds, azo compounds, aliphatic peroxyesters or mixtures thereof.

11. Process according to claim 10 wherein the free radical initiator is selected from dibenzoyl peroxide, dilauryl peroxide, bis(p-chlorobenzoyl peroxide), dicyclohexyl peroxydicarbonate, tert-butylperoctoate, 2,5-bis(2-ethylhexanoylperoxy)-2,5-dimethylhexane, tert-amylperoxy-2-ethylhexane, 2,2′-azobisisobutyronitrile, 2,2′-azobis(2-methyliso-butyronitrile), tert-butyl peroxyisobutyrate, tert-butyl peroxypivalate, tert-butyl peroxy-2-ethylhexanoate, tert-butylperoxyneodecanoate, tert-amyl peroxy-2-ethylhexanoate, tert-amyl peroxyneodecanoate, 2,5-bis(2-ethylhexanoylperoxy)-2,5-dimethylhexane, 2,5-dipivaloyl-2,5-dimethylhexane or 2,5-bis(2-neodecanoylperoxy)-2,5-dimethylhexane or mixtures thereof.

12. Process according to claim 10 wherein the free radical initiator is present in 0.01-5% by weight, preferably 0.1-2.5% by weight of the total emulsion.

13. Process according to claim 1 wherein the polymerizable material is present in 5-50% by weight, preferably 10-35% by weight of the total emulsion.

14. Process according to claim 1 wherein microcapsules obtained have a diameter of 10-250 μm.

15. Process according to claim 1 wherein polymerization is carried out at a temperature ranging 50-150° C., preferably 55-120° C.

16. Process according to claim 1 wherein polymerization is carried out for 1 to 8 hours.

17. Microcapsules obtainable by a process according to claim 1.

18. Microcapsules according to claim 17 configured for use in thermal protection and storage of heat.
